(19) United States
(12) Patent Application Publication
(10) Pub. No.: US 2025/0042810 A1
(43) Pub. Date: Feb. 6, 2025

(54) MICROWAVE HEAT TREATMENT METHOD FOR GRANULATED BLAST FURNACE SLAG

(71) Applicants: Zhengzhou University, Zhengzhou (CN); Henan Tianma New Materials Co., Ltd, Zhengzhou (CN)

(72) Inventors: Bingbing FAN, Zhengzhou (CN); Rui ZHANG, Zhengzhou (CN); Yongqiang CHEN, Zhengzhou (CN); Li GUAN, Zhengzhou (CN); Shuyun MA, Zhengzhou (CN); Hailong WANG, Zhengzhou (CN); Hongxia LI, Zhengzhou (CN); Guoqi LIU, Zhengzhou (CN); Limeng SONG, Zhengzhou (CN)

(73) Assignees: Zhengzhou University, Zhengzhou (CN); Henan Tianma New Materials Co., Ltd, Zhengzhou (CN)

(21) Appl. No.: 18/789,744

(22) Filed: Jul. 31, 2024

(30) Foreign Application Priority Data
Aug. 4, 2023 (CN) 202310981223.X

(51) Int. Cl. C04B 5/00

(52) U.S. Cl. CPC C04B 5/00

(57) ABSTRACT

A microwave heat treatment method for granulated blast furnace slag is provided, which includes the following steps: subjecting the granulated blast furnace slag to microwave heat treatment at a frequency of 900-930 MHz and then cooling the slag. Microwave rapid heating is utilized to remove the moisture in the granulated blast furnace slag, stress is generated inside the granulated blast furnace slag particles to promote the formation of cracks or the decomposition of the granulated slag particles into small particles. After the microwave reaches a certain power, the microwave is turned off, an air blower is turned on, and thermal stress is generated inside the granulated blast furnace slag particles, so that the particles are further promoted to generate cracks or fragmentation; and then the desired fine powder can be obtained by ball milling the granulated blast furnace slag after microwave heat treatment for a short time.

### CROSS REFERENCE TO THE RELATED APPLICATIONS

This application is based upon and claims priority to Chinese Patent Application No. 202310981223.X, filed on Aug. 4, 2023, the entire contents of which are incorporated herein by reference.

### TECHNICAL FIELD

The present invention relates to the technical field of slag resource recycling, and in particular, to a microwave heat treatment method for granulated blast furnace slag.

### BACKGROUND

Granulated blast furnace slag is formed by rapidly cooling the slag from an iron-making blast furnace in a high-temperature molten state with water. The granulated blast furnace slag is in the shape of granulated foam and milky white particles. The granulated blast furnace slag contains minerals such as vitreous body, dicalcium silicate, gehlenite and wollastonite, and mainly comprises chemical components of silicon oxide, calcium oxide, magnesium oxide, ferric oxide, aluminum oxide and the like, which is similar to the components of cement.

The granulated blast furnace slag can be used as a filler for cement after being crushed and ground. The existing granulated blast furnace slag has a median particle size of about 600 μm. Compared with cement clinker, the content of glass phase is higher, and long-time ball milling treatment is required to enable large-particle granulated slag to become fine powder. The ball milling treatment technology in the prior art has the problems of high energy consumption, low efficiency and the like. Therefore, it is of great significance to provide a method for preparing fine powder from granulated blast furnace slag with improved efficiency and reduced energy consumption.

### SUMMARY

To overcome the defects in the prior art, an objective of the present invention is to provide a microwave heat treatment method for granulated blast furnace slag. The microwave heat treatment method of the present invention forms cracks inside the granulated blast furnace slag through rapid heating and rapid cooling, and can significantly reduce the ball milling time.

To achieve the above objective, the present invention provides the following technical solutions.

The present invention provides a microwave heat treatment method for granulated blast furnace slag, which comprises the following steps: performing microwave heat treatment on the granulated blast furnace slag and then cooling the slag.

Specifically, the microwave heat treatment is performed at a frequency of 900-930 MHz.

Preferably, the microwave heat treatment is sequentially performed at a first power, a second power and a third power; the first power is 2.5-3.5 kW, the second power is 4.5-5.5 kW, and the third power is 6.5-7.5 kW.

Preferably, the first power, the second power and the third power are independently maintained for 1.5-2.5 min.

Preferably, the cooling is rapid cooling.

Preferably, the cooling is performed by adopting an air blower with a power of 5-10 kW.

Preferably, the cooled granulated blast furnace slag particles form cracks or are decomposed into small particles, and the cooled granulated blast furnace slag particles are subjected to ball milling to obtain fine powder of the granulated blast furnace slag; and the ball milling is performed for 30-60 min at a power of 3-5 kW.

The beneficial effects of the present invention are as follows.

According to the method of the present invention, microwave rapid heating is utilized to remove the moisture in the granulated blast furnace slag, and in the rapid moisture removal process, stress is generated inside the granulated blast furnace slag particles to promote the formation of cracks in the granulated slag particles or the decomposition of the granulated slag particles into small particles. After the microwave reaches a certain power, the microwave is turned off, an air blower is turned on, and thermal stress is generated inside the granulated blast furnace slag particles through the rapid temperature change, so that the particles are further promoted to generate cracks or fragmentation; and then the desired fine powder can be obtained by ball milling the granulated blast furnace slag after microwave heat treatment for 30-60 min at 3-5 kW. In the prior art, the desired fine powder can be obtained by performing ball milling for 2-3 h at 3-5 KW, so that the microwave heat treatment method of the present invention significantly shortens the subsequent ball milling time of the granulated blast furnace slag.

### BRIEF DESCRIPTION OF THE DRAWINGS

FIGS. 1A-1B are a microscopic morphologies of granulated blast furnace slag before and after microwave heat treatment in Example 1, wherein a represents before microwave heat treatment, and b represents after microwave heat treatment.

### DETAILED DESCRIPTION OF THE EMBODIMENTS

The present invention provides a microwave heat treatment method for granulated blast furnace slag, which comprises the following steps: performing microwave heat treatment on the granulated blast furnace slag and then cooling the slag.

Specifically, the microwave heat treatment is performed at a frequency of 900-930 MHz.

In the present invention, the frequency of the microwave heat treatment is preferably 910-920 MHz, further preferably 912-918 MHz, and more preferably 915-916 MHz.

In the present invention, the microwave heat treatment is sequentially performed at a first power, a second power and a third power; the first power is preferably 2.5-3.5 kW, further preferably 2.7-3.2 kW, and more preferably 2.9-3 kW; the second power is preferably 4.5-5.5 kW, further preferably 4.7-5.3 kW, and more preferably 5-5.1 kW; and the third power is preferably 6.5-7.5 kW, further preferably 6.7-7.3 kW, and more preferably 7-7.1 kW.

In the present invention, the first power, the second power and the third power are independently maintained for 1.5-2.5 min, further preferably 1.7-2.2 min, and more preferably 2 min.

In the present invention, the cooling is preferably rapid cooling; and the cooling is preferably cooling to room temperature.

In the present invention, the cooling is preferably performed by adopting an air blower, and the power of the air blower is preferably 5-10 KW, further preferably 6-9 kW, and more preferably 7-8 kW.

In the present invention, the cooled granulated blast furnace slag particles form cracks or are decomposed into small particles, and the cooled granulated blast furnace slag particles are preferably subjected to ball milling to obtain fine powder of the granulated blast furnace slag; the ball milling time is preferably 30-60 min, further preferably 35-55 min, and more preferably 40-50 min; and the power is preferably 3-5 kW, further preferably 3.5-4.5 kW, and more preferably 4 kW.

The technical solutions provided by the present invention will be described in detail below with reference to examples, which, however, should not be construed as limiting the scope of the present invention.

### Example 1

The granulated blast furnace slag was placed in an alumina crucible, the alumina crucible containing the granulated blast furnace slag was placed in a 915 MHz microwave, a microwave source was turned on, the microwave power was initially set to 3 kW for 2 min, then adjusted to 5 kW for 2 min and adjusted to 7 kW for 2 min, and the microwave source was immediately turned off. An air blower was then turned on, and the granulated blast furnace slag was rapidly cooled at the power of 8 kW. The granulated blast furnace slag particles were subjected to ball milling for 60 min at the power of 3 kW to obtain the fine powder of the granulated blast furnace slag.

### Example 2

The granulated blast furnace slag was placed in an alumina crucible, the alumina crucible containing the granulated blast furnace slag was placed in a 905 MHz microwave, a microwave source was turned on, the microwave power was initially set to 2.7 kW for 2.5 min, then adjusted to 4.7 kW for 2.5 min and adjusted to 6.7 kW for 2.5 min, and the microwave source was immediately turned off. An air blower was then turned on, and the granulated blast furnace slag was rapidly cooled at the power of 6 kW. The granulated blast furnace slag particles were subjected to ball milling for 50 min at the power of 4 kW to obtain the fine powder of the granulated blast furnace slag.

### Example 3

The granulated blast furnace slag was placed in an alumina crucible, the alumina crucible containing the granulated blast furnace slag was placed in a 925 MHz microwave, a microwave source was turned on, the microwave power was initially set to 3.3 kW for 1.5 min, then regulated to 5.3 kW for 1.5 min and adjusted to 7.3 kW for 1.5 min, and the microwave source was immediately turned off. An air blower was then turned on, and the granulated blast furnace slag was rapidly cooled at the power of 9 kW. The granulated blast furnace slag particles were subjected to ball milling for 40 min at the power of 4.5 kW to obtain the fine powder of the granulated blast furnace slag.

### Example 4

The granulated blast furnace slag was placed in an alumina crucible, the alumina crucible containing the granulated blast furnace slag was placed in a 918 MHz microwave, a microwave source was turned on, the microwave power was initially set to 3.1 kW for 2 min, then adjusted to 4.8 kW for 2 min and adjusted to 7 kW for 2 min, and the microwave source was immediately turned off. An air blower was then turned on, and the granulated blast furnace slag was rapidly cooled at the power of 7 kW. The granulated blast furnace slag particles were subjected to ball milling for 30 min at the power of 5 kW to obtain the fine powder of the granulated blast furnace slag.

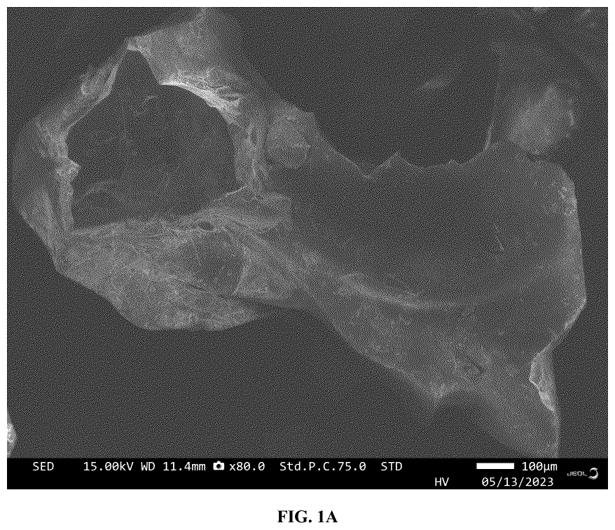

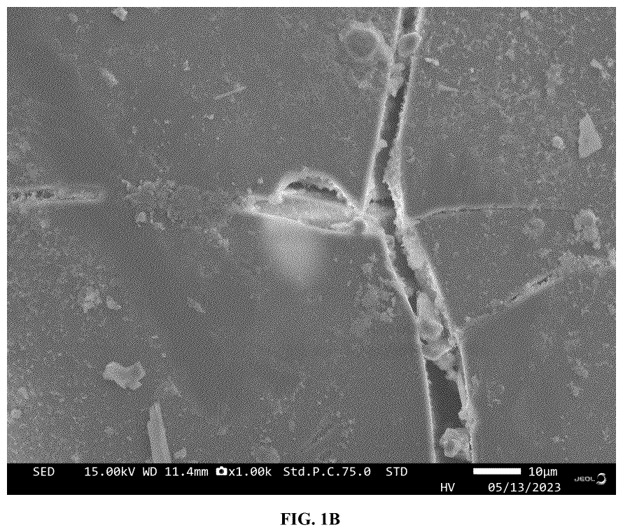

The microscopic morphology of the granulated blast furnace slag before and after microwave heat treatment in Example 1 is shown in FIGS. 1A-1B, wherein FIG. 1A represents before microwave heat treatment, and FIG. 1B represents after microwave heat treatment. It can be seen from FIG. 1B that, after the granulated blast furnace slag is subjected to microwave heat treatment, obvious cracks are formed in particles, so that the subsequent ball milling is facilitated, the energy consumption is reduced, and the efficiency is improved.

According to the method of the present invention, microwave rapid heating is utilized to remove the moisture in the granulated blast furnace slag, and in the rapid moisture removal process, stress is generated inside the granulated blast furnace slag particles to promote the formation of cracks in the granulated slag particles or the decomposition of the granulated slag particles into small particles. After the microwave reaches a certain power, the microwave is turned off, an air blower is turned on, and thermal stress is generated inside the granulated blast furnace slag particles through the rapid temperature change, so that the particles are further promoted to generate cracks or fragmentation; and then the desired fine powder can be obtained by ball milling the granulated blast furnace slag after microwave heat treatment for 30-60 min at 3-5 kW. In the prior art, the desired fine powder can be obtained by performing ball milling for 2-3 h at 3-5 KW, so that the microwave heat treatment method of the present invention significantly shortens the subsequent ball milling time of the granulated blast furnace slag.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A microwave heat treatment method for a granulated blast furnace slag, comprising the following steps: performing a microwave heat treatment on the granulated blast furnace slag and then cooling a treated granulated blast furnace slag;
wherein the microwave heat treatment is performed at a frequency of 900-930 MHz.

2. The microwave heat treatment method according to claim 1, wherein the microwave heat treatment is sequentially performed at a first power, a second power, and a third power; the first power is 2.5-3.5 kW, the second power is 4.5-5.5 kW, and the third power is 6.5-7.5 kW.

3. The microwave heat treatment method according to claim 2, wherein the first power, the second power, and the third power are independently maintained for 1.5-2.5 min.

4. The microwave heat treatment method according to claim 1, wherein the step of cooling is a rapid cooling.

5. The microwave heat treatment method according to claim 4, wherein the step of cooling is performed by adopting an air blower with a power of 5-10 kW.

6. The microwave heat treatment method according to claim 5, wherein cooled granulated blast furnace slag particles form cracks or are decomposed into small particles, and the cooled granulated blast furnace slag particles are subjected to a ball milling to obtain a fine powder of the granulated blast furnace slag; and the ball milling is performed for 30-60 min at a power of 3-5 Kw.

7. The microwave heat treatment method according to claim 3, wherein the step of cooling is a rapid cooling.

8. The microwave heat treatment method according to claim 7, wherein the step of cooling is performed by adopting an air blower with a power of 5-10 kW.

9. The microwave heat treatment method according to claim 8, wherein cooled granulated blast furnace slag particles form cracks or are decomposed into small particles, and the cooled granulated blast furnace slag particles are subjected to a ball milling to obtain a fine powder of the granulated blast furnace slag; and the ball milling is performed for 30-60 min at a power of 3-5 Kw.
